(19) United States
(12) Patent Application Publication
(10) Pub. No.: US 2007/0276077 A1
(43) Pub. Date: Nov. 29, 2007

(54) Composites

(75) Inventors: Dongsheng Mao, Austin, TX (US); Zvi Yaniv, Austin, TX (US)

Correspondence Address: FISH & RICHARDSON P.C., P.O BOX 1022, Minneapolis, MN, 55440-1022, US

(73) Assignee: NANO-PROPRIETARY, INC., Austin, TX (US)

(21) Appl. No.: 11/695,877

(22) Filed: Apr. 3, 2007

Related U.S. Application Data
(60) Provisional application No. 60/789,300, filed on Apr. 5, 2006.
(60) Provisional application No. 60/810,394, filed on Jun. 2, 2006.

(51) Int. Cl. C08K 3/34; B02C 17/16

(52) U.S. Cl. 524/445; 241/27; 524/847; 977/742

(57) ABSTRACT

Improved mechanical properties of both clay and carbon nanotube (CNT)-reinforced polymer matrix nanocomposites are obtained by pre-treating nanoparticles and polymer pellets prior to a melt compounding process. The nanoparticles are coated onto the surface of the polymer pellets by a ball-milling process. The nanoparticles thin film is formed onto the surface of the polymer pellets after the mixture is ground for a certain time.

This application for patent claims priority to U.S. Provisional Patent Applications Ser. Nos. 60/789,300 and 60/810,394, which are hereby incorporated by reference herein.

### BACKGROUND INFORMATION

Nanocomposites are composite materials that contain particles in the size range of 1-100 nm. These materials bring into play the submicron structural properties of molecules. These particles, such as clay and carbon nanotubes (CNT), generally have excellent properties, a high aspect ration, and a layered structure that maximizes bonding between the polymer and particles. Adding a small quantity of these additives (0.5-5%) can increase many of the properties of polymer materials, including higher strength, greater rigidity high heat resistance, higher UV resistance, lower water absorption rate, lower gas permeation rate, and other improved properties (T. D. Fornes, D. L. Hunter, and D. R. Paul, “Nylon-6 nanocomposites from Alkylammonium-modified clay: The role of Alkyl tails on exfoliation,” Macromolecules 37, pp. 1793-1798 (2004).

However, dispersion of the nanoparticles is very important to reinforce polymer matrix nanocomposites. Such dispersion of nanoparticles in the polymer matrix has been a problem. That is why those nanoparticle-reinforced nanocomposites have not achieved excellent properties as expected (Shamal K. Mhetre, Yong K. Kim, Steven B. Warner, Prabir K. Patra, Phaneshwar Katangur, and Autumn Dhanote “Nanocomposites with functionalized carbon nanotubes,” Mat. Res. Soc. Symp. Proc. Vol. 788 (2004)). Researches have claimed that in-situ polymerization of the nanocomposites can improve the dispersion of the nanoparticles. Better properties of the nanocomposites were somehow obtained. But in-situ polymerization is not proven to be an acceptable manufacturable process for the polymer production. Also used has been a melt compounding process, which is a more popular and manufacturable process to make those nanoparticle-reinforced polymer nanocomposites. But the results have not been satisfactory.

### BRIEF DESCRIPTION OF DRAWINGS

FIG. 1 illustrates a schematic diagram of a ball milling apparatus;

FIG. 2 illustrates a flow diagram of manufacturing nylon 11/clay/SEBS/composite resins; and

FIG. 3 illustrates a photograph of neat nylon 6 pellets on the left, which are transparent in contrast with nylon 6/CNT pellets on the right.

### DETAILED DESCRIPTION

Improved mechanical properties of both clay and carbon nanotube (CNT)-reinforced polymer matrix nanocomposites are obtained by pre-treating nanoparticles and polymer pellets prior to a melt compounding process. The nanoparticles are coated onto the surface of the polymer pellets by a ball-milling process. The nanoparticles thin film is formed onto the surface of the polymer pellets after the mixture is ground for a certain time.

The Ball-Milling Process:
1. Allows nanoparticles to attach onto the surface of the polymer pellets; and
2. Breaks the big clusters of the nanoparticles by the bombardment of the polymer pellets, which further disperse the nanoparticles in the polymer matrix after the melt compounding process.

Except for the clay and CNTs, other fillers such as graphite particles, carbon fibers, fullerence, carbon nanotubes, and ceramic particles may also be used.

Two cases are provided to illustrate embodiments of the invention.

Case 1: Nylon 11/clay nanocomposites

Nylon 11 pellets were obtained from Arkema Co., Japan (product name: RILSAN BMV-P20 PA11). Clay was provided by Southern Clay Products, US (product name: Cloisite® series 93A). It is a natural montmorillonite modified with a ternary ammonium salt.

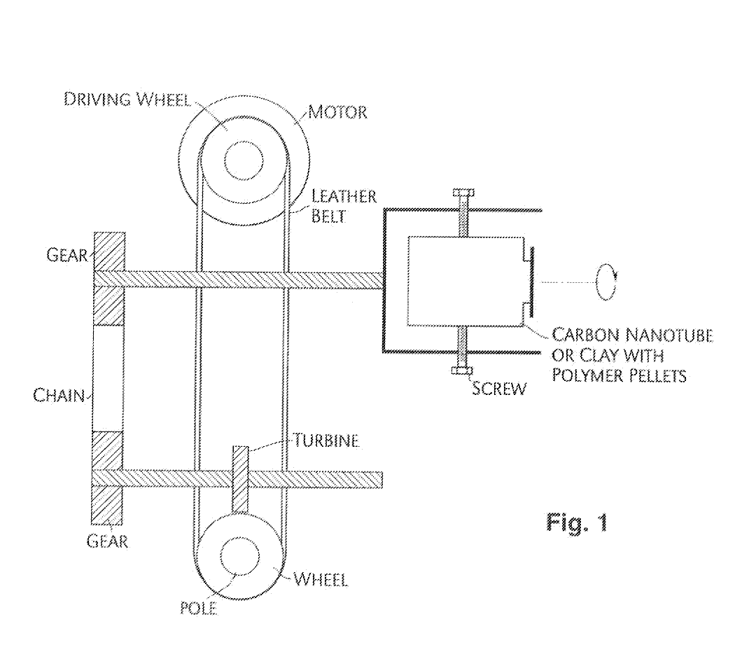

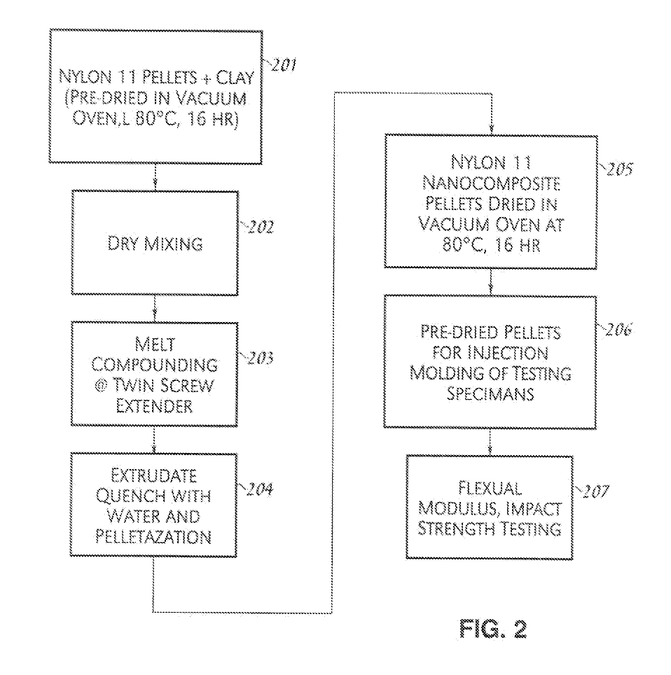

Referring to FIG. 2, in step 201, both clay and nylon 11 pellets were dried in vacuum oven at 80° C. for at least 16 hours to fully eliminate the moisture. Then they were put in a glass container to go through the ball milling process in step 202. FIG. 1 is a schematic diagram of a typical ball milling apparatus. The speed of this machine is about 50˜60 revolutions per minute. In this method, 5 wt. % and 10 wt. % of the clay powders were chosen for the experiment. The mixture was ground at least half an hour to allow all the clay particles to be attached onto the surface of the nylon 11 pellets. Solvents such as 1 PA, water, or acetone may be added into the mixture. For comparison, a direct mixing method was also used. The clay and nylon 11 were put in a plastic bag and hand shaken for at least half an hour.

After the mixtures were mixed by ball milling and direct mixing processes, a HAAKE Rheomex CTW 100 twin screw extruder (Germany) was used to blend nylon 6/clay/SEBS nanocomposites in step 203. Following are the parameters used in this process.

Screw zone 1 temperature-230° C.;

Screw zone 1 temperature-220° C.;

Screw zone 1 temperature-220° C.;

Die temperature-230° C.;

Screw speed-100 rpm.

A quantity of the nylon 11 pellets and clay for each operation is 1 pound because the twin screw needs to be cleaned using the mixture before collecting the composite resin. The synthesized resin may make 20 bars by the following injection molding process. In step 204, the nanocomposite fiber was quenched in water and palletized using a Haake PP1 Palletizer POSTEX after extrusion process. In step 205, the nanocomposite pellets were dried at 70° C. prior to injection molding process to make specimens. A Mini-Jector (Model 55, Mini-Jector Machinery Corp. Newbury, Ohio, USA) laboratory-scale injection molding machine was used in step 206 to make impact bars for physical testing in step 207. Samples were added with specific dimensions using ASTM-specified molds (ASTM D256 for impact strength testing, ASTM D790 for flexural modulus testing). Following are the parameters used:

Injection pressure-70 bar;

Holding pressure-35 bar;

Holding time-40 seconds;

Heating zone 1 temperature-220° C.;

Heating zone 2 temperature-220° C.;

Nozzle temperature-230° C.;

Mold temperature-60-80° C.;

The specimens were dried in a desiccator for at least 40 hours'conditioning before the testing process. Flexural modulus and impact of the samples were characterized using standard 3-point bending method.

Table 1 shows the mechanical properties (flexural modulus and impact strength)of the nylon 11/clay/SEBS composites with different weight ratios.

TABLE 1

| | | Flexural | Impact strength |
|---|---|---|---|
| Sample ID | Pre-treatment | modulus (GPa) | (kgf cm/cm) |
| Neat nylon | | 0.553 | |
| 11 | | | |
| Nylon | Direct-mixing | 0.928 | 21.2 |
| 11/clay | | | |
| (5 wt. %) | | | |
| Nylon | Ball-milling | 1.04 | 30.3 |
| 11/clay | | | |
| (5 wt. %) | | | |
| Nylon | Direct-mixing | 1.33 | 20.4 |
| 11/clay | | | |
| (10 wt. %) | | | |
| Nylon | Ball-milling | 1.35 | 27.8 |
| 11/clay | | | |
| (10 wt. %) | | | |

It can be seen that the mechanical properties of nylon 11/clay nanocomposites pre-treated by ball milling process are better than those by the direct mixing process at the same loading of clay.

Case 2: Nylon 6/carbon nanotube nanocomposites

Nylon 6 pellets were obtained from UBE Co., Japan (product name: SF1018A). Clay was provided by Southern Clay Products, US (product name: Cloisite® series 93A). The carbon nanotubes used in this case were double wall CNTs (DWNTs), DWNTs were obtained from Nanocyl, Inc., Belgium

A similar process as described above with respect to FIG. 2 was used. Both CNTs and nylon 6 pellets were dried in a vacuum oven at 80° C. for at least 16 hours to fully eliminated the moisture. Then they were put in a glass container to go through the ball milling process. In this case, 0.4 wt. % CNTs was used in nylon 6 matrix.

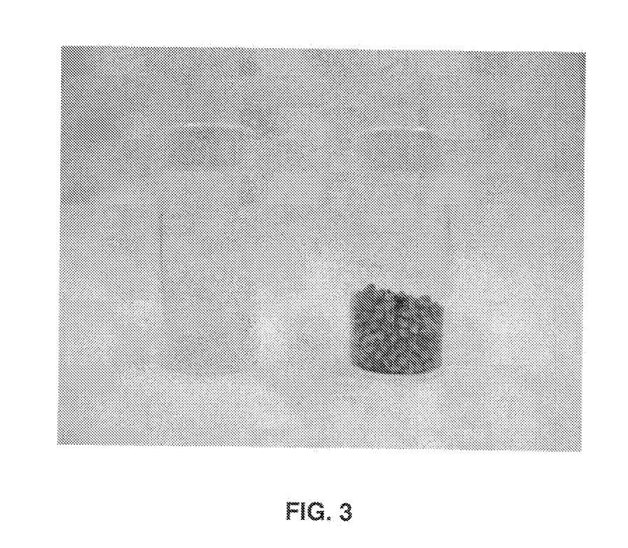

FIG. 3 shows a picture of neat nylon 6 pellets (left) and nylon 6/CNT right. Neat nylon 6 is transparent, while it was black after the ball milling process with CNTs because CNTs have a black color. It means that CNTs were evenly coating onto the surface of the nylon 6 pellets.

After the mixtures were mixed by ball milling a HAAKE Rheomex CTW 100 twin screw extruder (Germany) was used to blend nylon 6/clay/SEBS nanocomposites Following are the parameters used in this process:

Screw zone 1 temperature-240° C.;

Screw zone 1 temperature-230° C.;

Screw zone 1 temperature-230° C.;

Die temperature-220° C.;

Screw speed-100 rpm.

A quantity of the nylon 6 pellets and CNTs for each operation was 1 pound because the twin screw needed to be cleaned using the mixture before collecting the composite resin. The synthesized resin made 20 bars by following injection molding process. The nanocomposite fiber was quenched in water and palletized using a Haake PP1 Palletizer POSTEX after the extrusion process. The nanocomposite pellets were dried at 70° C. prior to the injection molding process to make specimens. A Mini-Jector (Model 55, Mini-Jector Machinery Corp. Newbury, Ohio, USA) laboratory-scale injection molding machine was used to make input bars for physical testing. Samples were molded with specific dimensions using ASTM-specified molds (ASTM D638 for tensile strength testing ASTM D790 for flexural modulus testing). Following are the parameters used:

Injection pressure-70 bar;

Holding pressure-35 bar;

Holding time-40 seconds;

Heating zone 1 temperature-230° C.;

Heating zone 2 temperature-230° C.;

Nozzle temperature-240° C.;

Mold temperature-60-80° C.;

For comparison, neat nylon 6 specimens were also molded. The specimens were dried in a desiccator for at least 40 hours' conditioning before the testing process.

Table 2 shows the mechanical properties (tensile strength and impact strength) of the nylon 6/CNT nanocomposite.

TABLE 2

| | Tensile strength | Flexural |
|---|---|---|
| Sample ID | (MPa) | modulus (GPa) |
| Neat nylon 6 | 76 | 2.5 |
| Nylon | 81 | 3.0 |
| 6/CNT (0.4 wt. %) | | |

It can be seen clearly that the mechanical properties of nylon 6/CNT nanocomposites pre-treated by the ball milling process were better than those of neat nylon 6. Nylon 6/CNT nanocomposites synthesized by melt compounding process hold worse mechanical properties than neat nylon 6 (Dhanote, “Nanocomposites with functionalized carbon nanotubes,” Mat. Res. Soc. Symp. Proc. Vol. 788, L11.17.1-L11.17.6).

1. A method comprising mixing nanoparticles with nylon pellets using a ball milling apparatus.

2. The method as recited in claim 1, wherein the nylon pellets are nylon 11 pellets.

3. The method as recited in claim 1, wherein the nylon comprises nylon 6 pellets.

4. The method as recited in claim 1, wherein the nanoparticles comprise clay nanoparticles.

5. The method as recited in claim 1, wherein the nanoparticles comprise carbon nanotubes.

6. The method as recited in claim 1, wherein the nanoparticles comprise graphite particles.

7. The method as recited in claim 1, wherein the nanoparticles comprise carbon fibers.

8. The method as recited in claim 1, wherein the nanoparticles comprise fullerenes.

9. The method as recited in claim 1, wherein the nanoparticles comprise ceramic particles.

10. The method as recited in claim 1, wherein the nylon pellets are covered with the nanoparticles after mixing using the ball milling apparatus.

11. A composition of matter comprising nylon pellets with nanoparticles attached to the surface thereof.

12. The composition as recited in claim 11, wherein the nylon pellets are nylon 11 pellets.

13. The composition as recited in claim 11, wherein the nylon comprises nylon 6 pellets.

14. The composition as recited in claim 11, wherein the nanoparticles comprise clay nanoparticles.

15. The composition as recited in claim 11, wherein the nanoparticles comprise carbon nanotubes.

16. The composition as recited in claim 11, wherein the nanoparticles comprise graphite particles.

17. The composition as recited in claim 11, wherein the nanoparticles comprise carbon fibers.

18. The composition as recited in claim 11, wherein the nanoparticles comprise fullerenes.

19. The composition as recited in claim 11, wherein the nanoparticles comprise ceramic particles.

20. The composition as recited in claim 11, wherein the nylon pellets are covered with the nanoparticles after mixing using the ball milling apparatus.
